(19) United States
(12) Patent Application Publication
(10) Pub. No.: US 2001/0038390 A1
(43) Pub. Date: Nov. 8, 2001

(54) Image selection method, system and program

(76) Inventors: Daisuke Takaya, Kamakura (JP); Masaru Tanaka, Yokohama (JP); Mitsuaki Horidome, Kawasaki (JP)

Correspondence Address: Mattingly, Stanger & Malur, P.C., 104 East Hume Avenue, Alexandria, VA, 22301, US

(21) Appl. No.: 09/809,255

(22) Filed: Mar. 16, 2001

(30) Foreign Application Priority Data
Apr. 25, 2000 (JP) 2000-124018

(51) Int. Cl. G09G 5/00

(52) U.S. Cl. 345/671

(57) ABSTRACT

A method for selecting a graphics primitive in a drawing prepared on a computer includes steps of setting an enlargement display area wherein enlarged display is provided and a compression display area wherein compressed display is provided in a graphics primitive display area, extracting graphics primitive data present in the set enlargement and compression display areas, dividing the-extracted graphics primitive data into a plurality of vector data for the set respective enlargement and compression display areas, and subjecting the divided vector data to coordinate transformation to enlarge or compress the graphics primitive data, thereby displaying graphics primitive data on an enlargement display area.

### BACKGROUND OF THE INVENTION

1. Field of the Invention

The present invention relates to an apparatus for selecting a graphics element or primitive created on a computer, and more particularly, to a technique which is effectively used in a graphics primitive selecting apparatus which can display one of graphics primitives created on a computer as enlarged and also can display a graphics primitive present around the enlarged graphics primitive as compressed to facilitate selection of the primitive in a specific area.

2. Description of the Related Art

As a conventional method for displaying a graphics primitive as enlarged, there is disclosed a system wherein a pointer is displayed at an enlarge display position in a drawing with an attached window so that a periphery of a position pointed by the pointer in the attached window is displayed as enlarged and the attached window is provided so as not to cover a predetermined area around the periphery of the pointer, as disclosed in JP-A-10-133639.

Also disclosed in JP-A-7-146951 is a document preparing apparatus which, when a document is prepared with use of a reduced screen, a location which is indicated by a pointer is displayed always with an enlarged display window, thus lightening scrolling operation of the window being displayed as enlarged.

Disclosed in JP-A-7-93574 is a method wherein, when a position to be enlarged is specified by a pointer, an enlarged range corresponding to the position is set to extract data present within the set enlarged range for an enlarged display.

Further disclosed in JP-A-6-28438 is a method wherein areas to be enlarged and buffered are set to copy the values of pixels within the enlargement and buffer areas into the area after enlarged.

JP-A-4-107786 discloses a method wherein a wide range of drawing or the like is displayed on a single display screen and even details of a part in the wide range is also displayed on the same screen.

### SUMMARY OF THE INVENTION

The above method for displaying as enlarged as disclosed in JP-A-7-93574 has a problem that an area around the pointer is hidden by the enlarged display window, which makes it difficult to accurately grasp the position of the point with respect to the entire screen.

The above method for displayed as enlarged as disclosed in JP-A-7-146951 also has a problem that the pointer its positioned away from the enlarged display window, so that, when an operator compares the point with the enlarged display window, the operator's line of sight must troublesomely move between the two windows, imposing a burden on the operator.

The method for displaying as enlarged as disclosed in JP-A-10-133639 has a problem that an enlarged display window is provided in the vicinity of the pointer and at such a location as not to cover and hide the periphery of the pointer, but an area hidden by the enlarged display window is still present and thus a graphics primitive hidden by the enlarged window cannot be referred to.

The above method for displaying as enlarged as disclosed in JP-A-6-28438 has a problem that enlargement or reduction is realized by copying the values of pixels, so that a gap between the pixels or overlapping between pixels takes place, with the result that continuity as a graphics primitive is deteriorated, thus making it difficult to take a correlation between an input point and data of the graphics primitive at the time of pixel specification.

In the method disclosed in JP-A-4-107786, since a reduced area is not set, the entire drawing is displayed as reduced.

It is therefore an object of the present invention to provide a technique which can solve the above problems and can improve an easy of operation and working efficiency of a graphics processing system.

In accordance with the present invention, there is provided a graphics primitive selecting apparatus for selecting primitives generated on a computer, wherein data of a graphics primitive in an enlargement display area is displayed as enlarged while data of a graphics primitive in a compression display area therearound is displayed as compressed.

With the graphics primitive selecting apparatus of the present invention, in the enlargement display area specified by a pointer or the like on a display unit as well as the-compression display area therearound, the graphics primitive data is resolved into vector data, and vector data in the compression display area is further divided into smaller data. In the enlargement display area, the vector data is enlarged and displayed around the position of the pointer as its center. In a predetermined range outside of the enlargement area, on the other hand, the vector data is subjected to a coordinate transformation so that the range is compressed radially outwardly for its compressed display. In this enlarged display method, all graphics primitives included in the original drawing can be displayed and any area covered and hidden by the enlargement display area can be eliminated. Further, a coordinate point input by the pointer for primitive specification can be accurately selected with an enlarged display.

In accordance with the present invention, as mentioned above, an enlarged area can be displayed on a screen without covering and hiding any area with the enlarged area. Further, an operator can operate on the screen with use of the enlarged area while grasping the accurate position of the point in the entire drawing. In addition, even after a graphics primitive is displayed as enlarged or compressed, the primitive can keep its thickness and continuity. Thus, when the operator wants to select and specify a graphics primitive to be edited in a graphics primitive processing system such as CAD, the operator can easily specify a graphics primitive in a complicated area, can handle it while referring to a positional relationship with other graphics primitives, thus shortening a time necessary for operator's primitive specifying operation and improving the easy of operation and working efficiency of the system.

As has been explained above, in accordance with the graphics primitive selecting apparatus, graphics primitive data in an enlargement display area can be displayed as enlarged, and simultaneously a graphics primitive data therearound can be displayed as compressed, whereby the system can be improved in its operational ease and working efficiency.

### BRIEF DESCRIPTION OF THE DRAWINGS

FIGS. 1A and 1B schematically show how data on a graphics primitive is displayed a graphics primitive as enlarged in a embodiment of the present invention;

FIG. 2 shows a software configuration of an enlarged display method in a graphics primitive selecting apparatus in accordance with the present embodiment;

FIG. 3 is a flowchart showing a procedure of enlarged display operations in the present embodiment;

FIG. 4 shows, as an example, a relationship between a distance from a pointer and a drawing scale on a drawing at the time of enlarged display in the present embodiment;

FIG. 5 shows, as an example, how to display as compressed in the present embodiment;

FIG. 6 shows, as another example, a relationship between a distance of a point and a drawing scale on a drawing at the time of the enlarged display in the present embodiment;

FIG. 7 shows a software configuration of an enlarged display method in a three-dimensional-image graphics primitive selecting apparatus;

FIGS. 8A and 8B are diagrams for explaining how to display a three-dimensional image; and

FIGS. 9A and 9B schematically show enlarged display of a three dimensional image.

### DETAILED DESCRIPTION OF THE EMBODIMENTS

Explanation will be made in connection with a graphics primitive selecting apparatus for selecting a graphics primitive in a drawing prepared on a computer in accordance with an embodiment of the present invention.

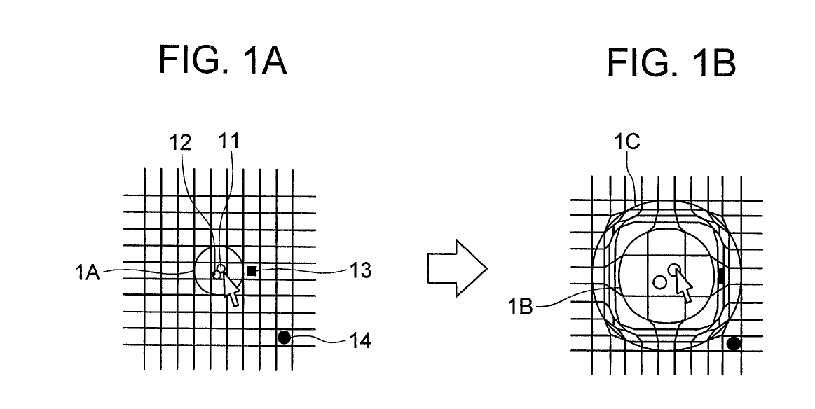

FIGS. 1A and 1B schematically show how to display data of a graphics primitive as enlarged in the present embodiment, wherein FIG. 1A shows data of a graphics primitive displayed in a normal size on a display unit, and FIG. 1B shows data of the graphics primitive when an area in the vicinity of a pointer is displayed as enlarged by a graphics primitive selecting apparatus in accordance with the present embodiment.

An area 1A in FIG. 1A is an circular area to be enlarged and having a radius r. An area 1B in FIG. 1B is an enlarged circular area having an enlargement factor s and a radius sr. An area 1C in FIG. 1B is a compressedly-displayed area defined by the circular areas of the radii sr and R. A graphics primitive 11 is a graphics primitive to be selected by an operator; a graphics primitive 12 is one present in the vicinity of the graphics primitive 11; a graphics primitive 13 is one present around the graphics primitive 11, that is, away by a distance r or more from the position of the pointer and in a range in less than the radius R; and a graphics primitive 14 is one present at a position well away from the graphics primitive 11, that is, away by a distance of R or more from the pointer position.

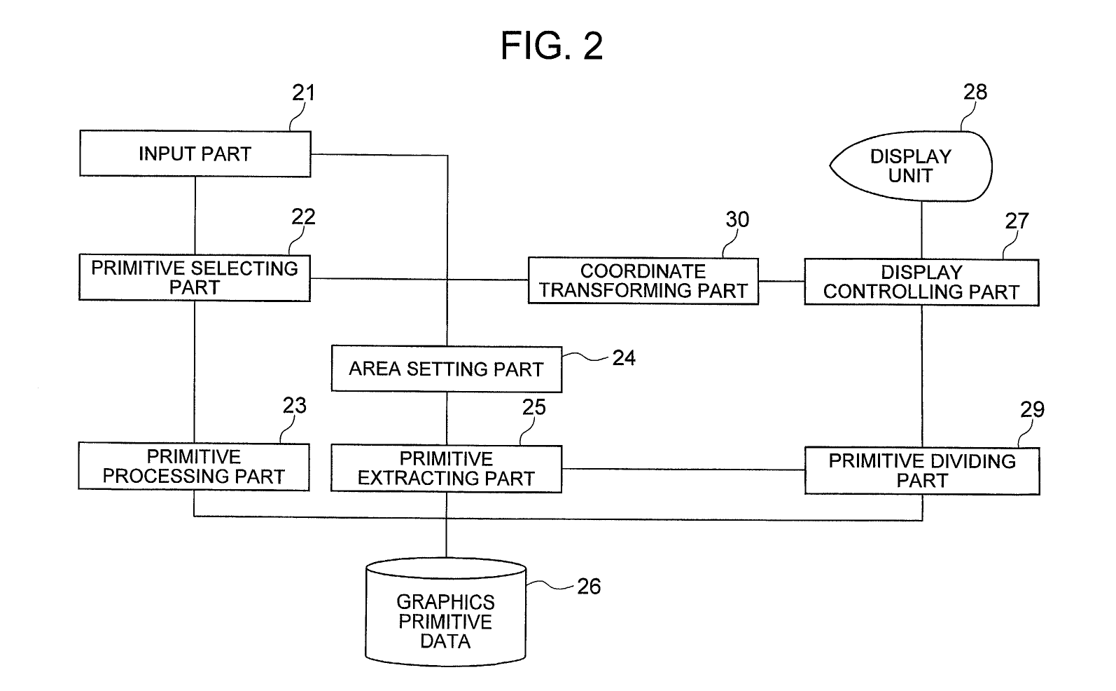

FIG. 2 shows a software configuration of an enlargedly displaying method in the graphics primitive selecting apparatus in accordance with the present embodiment. The graphics primitive selecting apparatus of the present embodiment shown in FIG. 2 includes an input part 21, a primitive selecting part 22, a primitive processing part 23, an area setting part 24, a primitive extracting part 25, a display controlling part 27, a primitive dividing part 29, and a coordinate transforming part 30.

The input part 21 acts to acquire a position on the drawing from an input device such as a mouse. The primitive selecting part 22 selects a graphics primitive located at the position acquired by the input part 21. The primitive processing part 23 processes the selected graphics primitive to update graphics primitive data 26.

The area setting part 24, on the basis of the position acquired by the input part 21, sets an enlargement display area to be displayed as enlarged as well as a compression display area to be displayed as compressed in a graphics primitive display area. The primitive extracting part 25 extracts graphics primitive data included in the enlargement and compression display areas set by the area setting part 24 from the graphics primitive data 26.

The display controlling part 27 displays the graphics primitive data 26 subjected by the coordinate transforming part 30 on a display unit 28. The primitive dividing part 29 divides the extracted graphics primitive data 26 into a plurality of vector data. The coordinate transforming part 30 subjects the vector data extracted by the primitive extracting part 25 to a coordinate transformation to enlarge or compress the graphics primitive data 26.

A program for causing the graphics primitive selecting apparatus to function as the input part 21, primitive selecting part 22, primitive processing part 23, area setting part 24, primitive extracting part 25, display controlling part 27, primitive dividing part 29 and coordinate transforming part 30, is recorded in a recording medium such as CD-ROM medium, stored in a magnetic disk or the like, and then loaded to a memory for execution. In this connection, the recording medium for recording of the program may be of another type other than CD-ROM.

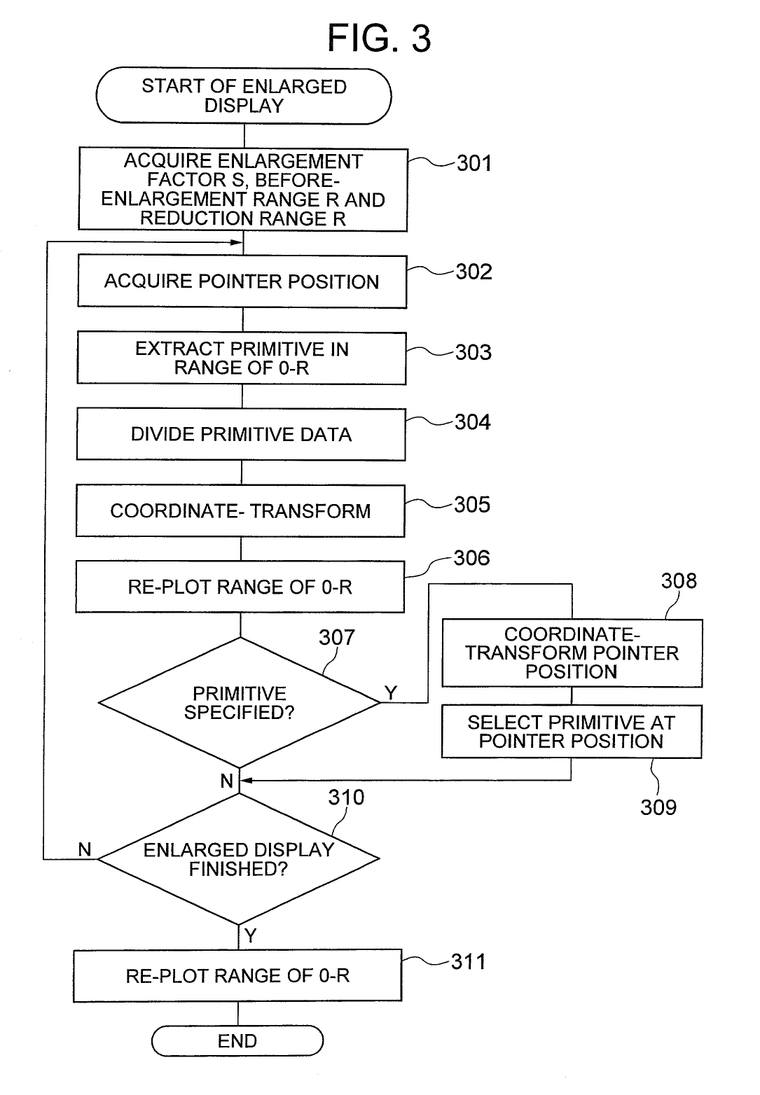

FIG. 3 shows a flowchart showing a procedure of enlargedly displaying operations in the present embodiment. In the graphics primitive selecting apparatus of the present invention, when the enlargedly displaying function starts, the area setting part 24 first acquires a radius r and enlargement factor s of an enlargement range and the radius R of a compression range from a set file in a step 301.

In a step 302, next, the area setting part 24 acquires a position of a pointer of an input device such as a mouse from the input part 21, and sets an enlargement display area to be displayed as enlarged around the position as its center and a compression display area to be displayed as compressed in a graphics primitive display area.

In this case, it is also considered that the operator dynamically changes the information about the enlarged range r, enlargement factor s, etc. with use of a menu or button on the screen, or an input device such as a wheel mouse while referring to a result displayed on the screen. Further, after once enlarged displayed, the enlargement display area may be fixed until the enlarged display is released or may be moved following up the position of the pointer.

In a step 303, the primitive extracting part 25 extracts data of primitives present in ranges defined by distances of 0 to r and distances of r to R from the point position. In a next step 304, the primitive dividing part 29 divides the vector data into smaller primitive data of the ranges of 0-r, r-R and R and more. The primitive dividing part 29 further divides data present within the range of r-R into vector data of smaller distances.

In a step 305, the coordinate transforming part 30 performs coordinate transformation to transform start and end points of the vector data in the range defined by distances 0-r from the pointer position to a range defined by distances 0-sr and to transform start and end points of the vector data in the range defined by distances r-R from the pointer position to a range defined by distances sr-R from the pointer. In a step 306, the display controlling part 27 re-plots the range of 0-R. Through these operations, the graphics primitive 13 present in the range of the distances r-R from the pointer is displayed as compressed toward radially outwardly, and the graphics primitive 14 present in the range of distances R and more from the pointer is displayed in a normal size.

Through the aforementioned display control, the graphics primitive 11 to be selected and the graphics primitive 12 present in the vicinity thereof are displayed as enlarged, so that the user can easily specify it. Further, since the graphics primitives 13 and 14 are not covered by the window due to their enlarged display, the operator can edit the graphics primitive 11 while referring to these primitives. Further, because of the vector display, even after displayed as enlarged, the primitives can hold its segment thickness and continuity.

In a step 307, the primitive selecting part 22 examines whether or not the graphics primitive of the data is specified. When the graphics primitive of the data is specified, the control proceeds to a step 308 to perform coordinate transformation over the position of the pointer. Thereafter the apparatus goes to a step 309 to select a graphics primitive at the specified position, and the selected graphics primitive is processed by the primitive processing part 23 to perform primitive editing operation to update the graphics primitive data 26.

In a step 310, the area setting part 24 examines whether or not the enlarged display was released. When the enlarged display was released, the apparatus proceeds to a step 311 where the enlargement display area and compression display area are re-plotted in a normal size display format by the display controlling part 27.

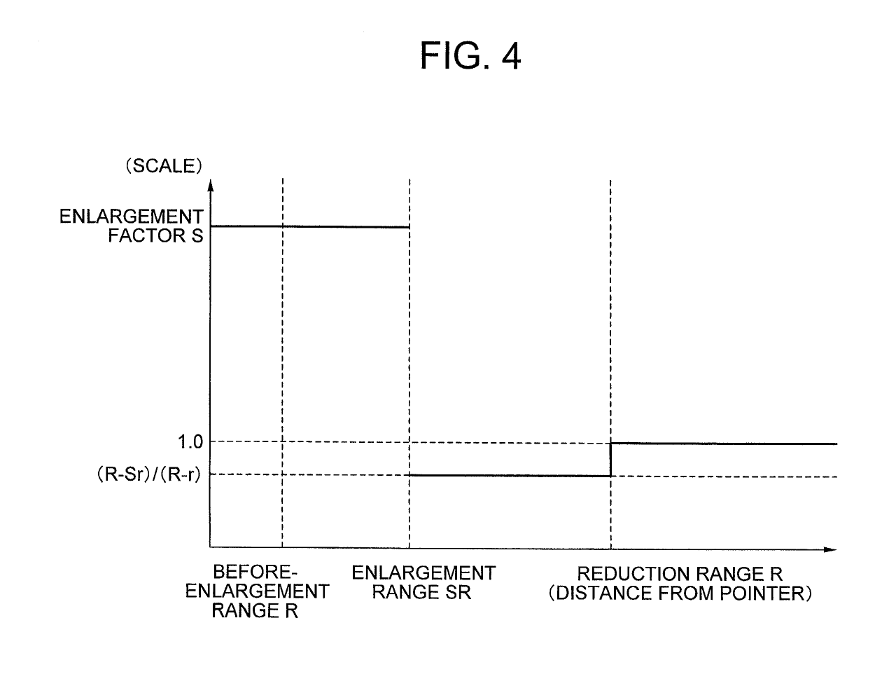

FIG. 4 shows, as an example, a relationship between distance from the position of a pointer on a drawing and drawing scale in an enlarged display mode of the present embodiment. As shown in FIG. 4, the graphics primitive selecting apparatus of the present embodiment enlarges the graphics primitive within the area 1A defined by the radius r and by the radius R by an enlargement factor of s and displays it in the area 1B defined by the radii s and r. The apparatus also compresses the graphics primitive within the area 1C defined by the radii r and R by an enlargement factor of (R−sr)/(R−r) toward its radial direction. An area covered by the radius R or more from the pointer position is displayed in a normal scale or size.

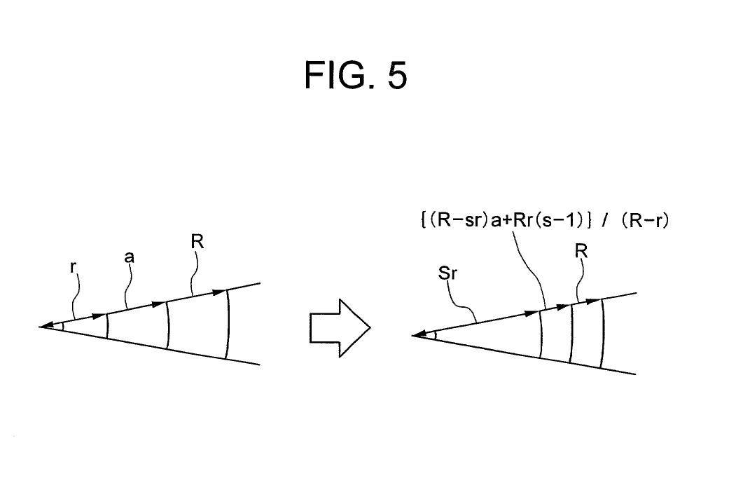

FIG. 5 shows, as an example, a compressed display in the present embodiment. As shown in FIG. 5, the graphics primitive selecting apparatus of the present embodiment performs coordinate transformation to transform a point at a position away by a distance a from the pointer position is transformed with respect to coordinate to a distance of {(R−sr)a+Rr(s−1)}/(R−r) from the pointer.

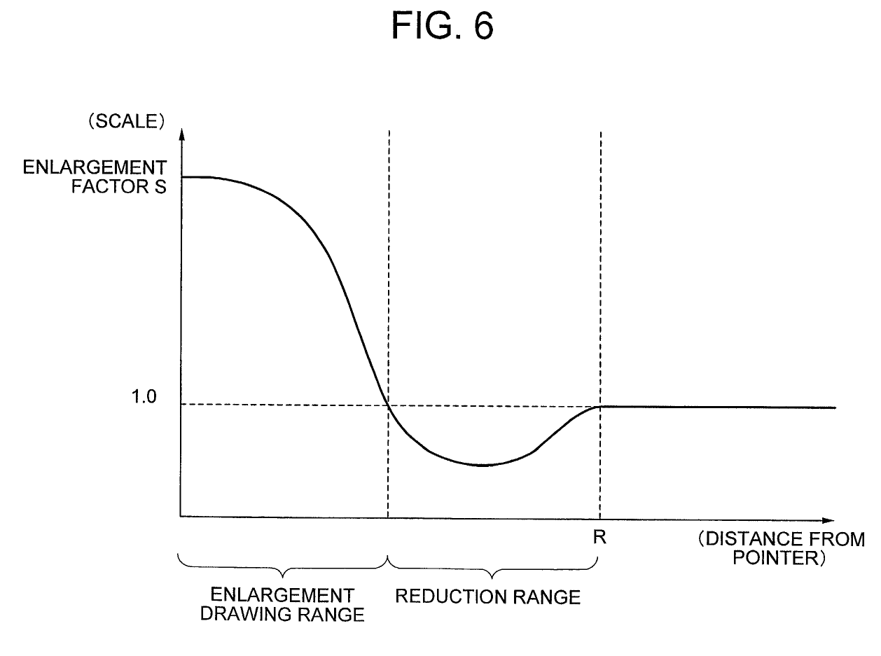

FIG. 6 shows, as another example, a relationship between a distance from the position of a pointer on a drawing in an enlarged display mode of the present embodiment and a scale of the drawing. As shown in FIG. 6, the graphics primitive selecting apparatus of the present embodiment may vary the enlargement factor s continuously. More specifically, as shown in FIG. 6, the apparatus displays a graphics primitive at the pointer position by an enlargement factor s, gradually decrease the enlargement factor as a position goes away from the pointer position, and from a certain position on, provides compressed display. And as the position approaches an area to be displayed in the normal scale, the enlargement factor is again increased. In this way, since the enlargement factor of the graphics primitive is continuously varied with a distance from the pointer, smoother display can be provided on the screen with a good visual recognizability.

Explanation will next be made in connection with a case where the graphics primitive selecting apparatus of the present embodiment is applied to a three-dimensional graphics primitive.

This is based on an idea that, when the graphics primitive selecting apparatus is applied even to a two-dimensional image projected on a screen, the apparatus can similarly display a three-dimensional graphics primitive.

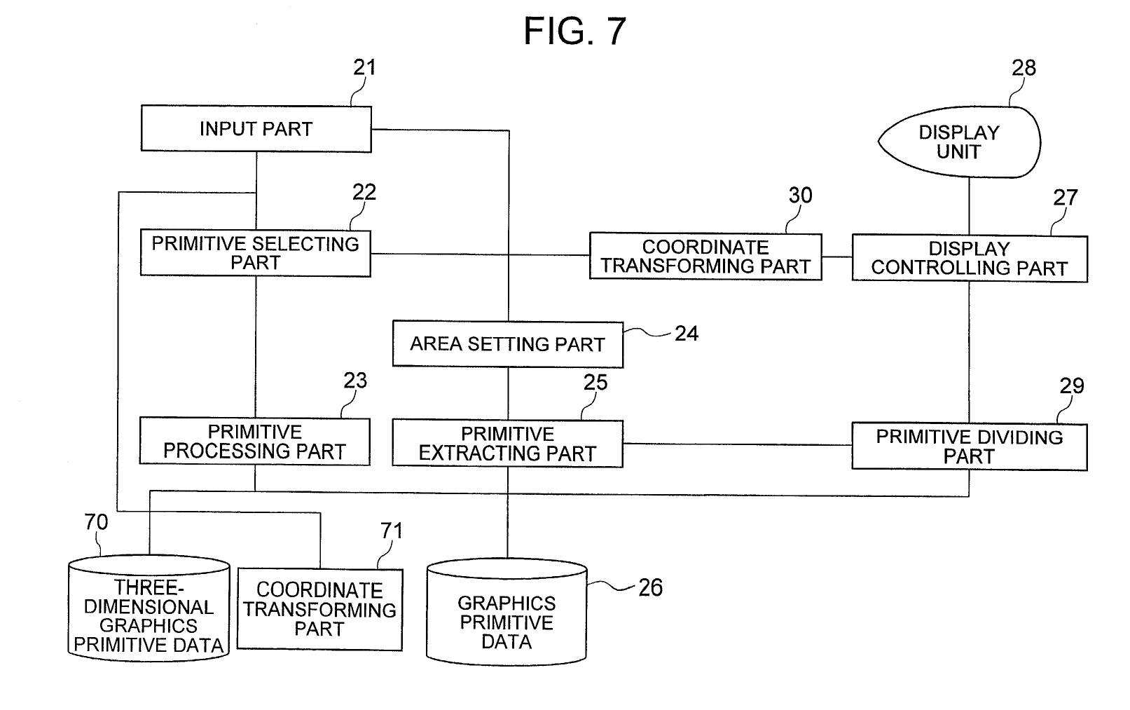

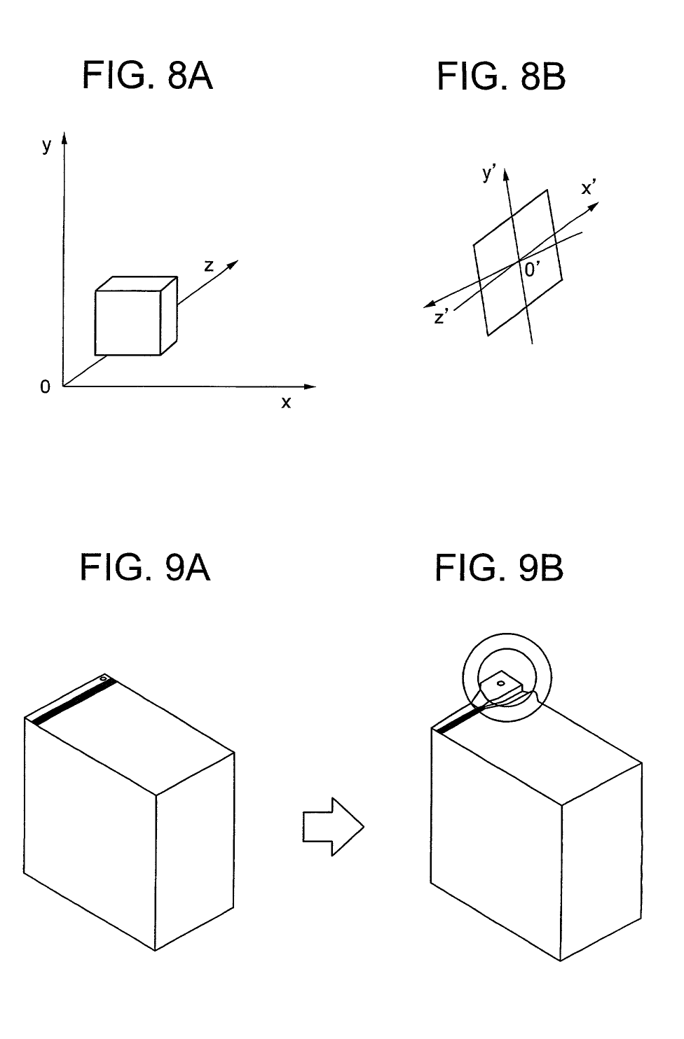

FIG. 7 shows a software configuration of an enlargedly displaying method of the graphics primitive selecting apparatus when applied to a three-dimensional graphics primitive. FIG. 7 is different from FIG. 2 in that three-dimensional graphics primitive data 70 and a coordinate transforming part 71 for transforming three-dimensional graphics primitive data to two-dimensional graphics primitive data 72 in FIG. 7. The three-dimensional graphics primitive data 70 has a coordinate point (x, y, z) of a graphics primitive. In order to display such a graphics primitive on a display screen, a screen spaced by a constant distance from a graphics primitive is assumed and a two-dimensional graphics primitive is projected on the screen. FIG. 8A shows a three-dimensional graphics primitive and FIG. 8B shows a screen for projection thereof to generate a two-dimensional image. Assuming that a coordinate transformation matrix T transforms a coordinate point (x, y, z) in a coordinate system of three-dimensional graphics primitive to a coordinate point (x′, y′, z′) in a coordinate system of the screen (screen coordinate system), then a relationship expressed by a following equation is satisfied.

$$( \begin{matrix}{x}^{′} \\ {Y}^{′} \\ {Z}^{′}\end{matrix} ) = T ( \begin{matrix}x \\ y \\ z\end{matrix} )$$

wherein, T includes such a parallel movement as to make an origin of the screen coordinate system to coincide with an origin of a world coordinate system, such rotation around a y axis as a z′ axis is overlapped with a (y, z) plane, such rotation around an x axis as the z′ axis coincides with a z axis, and such rotation around the z axis as an x′ axis coincides with the x axis. At this time, a two-dimensional graphics primitive projected on the screen has a coordinate point (x′, y′). The coordinate transforming part 71 subjects a three-dimensional graphics primitive data specified by the input part 21 to such a coordinate transformation to generate two-dimensional graphics primitive data 72. In this connection, the coordinate transforming part 71 also performs coordinate transformation such as rotation of a three-dimensional graphics primitive or enlargement of the entire three-dimensional graphics primitive. In other words, when accepting a command indicative of a rotation of three-dimensional graphics primitive data specified by the input part 21 by 90 degrees to right side, the coordinate transforming part 71 finds a coordinate point of the three-dimensional image rotated by 90 degrees to right side, and performs coordinate transformation over the found coordinate point to generate the two-dimensional graphics primitive data 72. The two-dimensional graphics primitive data 72 thus generated is displayed on the display screen under control of the display controlling part 27. For example, when a three-dimensional graphics primitive of rectangular parallelopiped is displayed on the display screen, it is as shown in FIG. 9A.

When the operator-now specifies an apex of the rectangular parallelopiped as its part with use of an input device such as a mouse for its enlarged display, the apparatus produces such an enlarged display as shown by FIG. 9B. In other words, when a position is specified by the mouse, the position on the display screen is acquired by the input part 21 and a graphics primitive at the position acquired by the input part 21 is selected by the primitive selecting part 22. And the selected graphics primitive is processed by the primitive processing part 23 and the two-dimensional graphics primitive data 72 is updated. The input part 21, primitive selecting part 22 and primitive processing part 23 explained here perform the same operations as those already explained earlier. The area setting part 24, primitive extracting part 25, display controlling part 27, primitive dividing part 29 and coordinate transforming part 30 also perform the same operations as those already explained earlier. This is, as already explained above, because three-dimensional graphics primitive data is arranged in such a manner as to treat the two-dimensional graphics primitive data 72 and thus can be treated in the same manner as the graphics primitive data 26 explained earlier.

Accordingly a flowchart for the enlarged display is the same as that of FIG. 3 already explained.

When the operator specifies a rotation of two-dimensional graphics primitive data with use of a mouse or the like, this causes the coordinate transforming part 71 to perform coordinate transformation for display thereof on the display unit. When the operator wants to provide an enlargement display, operator's specification of a desired position with use of a mouse or the like enables the enlargement display, as already explained earlier.

In accordance with the present embodiment, as mentioned above, since an enlarged drawing can be displayed without covering an original drawing, the operator can handle the original drawing with use of the enlarged drawing. Further, even after displayed as enlarged and compressed, the graphics primitive can hold its thickness and continuity. And upon selection and specification of a graphics primitive to be edited in the graphics primitive processing system such as CAD, the operator can easily specify a graphics primitive having a complicated part and can handle it while referring to a relational relationship with other primitives. As a result, an operator's time necessary for primitive specifying operation can be shortened and thus the graphics primitive processing system can be improved in its operability and working efficiency.

As has been explained in the foregoing, in accordance with the graphics primitive selecting apparatus of the present embodiment, the apparatus enlarges and displays graphics primitive data within an enlargement display area and compresses and displays graphics primitive data within the compression display area therearound, whereby the apparatus can be improved in its operability and working efficiency.

In accordance with the present invention, since graphics primitive data in the enlargement display area is displayed as enlarged and graphics primitive data in the compression display area therearound is displayed as compressed, the graphics primitive processing system can be improved in its operability and working efficiency.

What is claimed is:

1. A method for selecting a graphics primitive generated on a computer, comprising the steps of:
setting an enlargement display area wherein enlarged display is provided and a compression display area wherein compressed display is provided in a graphics primitive display area;
extracting graphics primitive data from said set enlargement and compression display areas;
dividing said extracted graphics primitive data into a plurality of vector data for said respective set enlargement and compression display areas; and
subjecting said divided vector data to a coordinate transformation to enlarge or compress said extracted graphics primitive data.

2. A method for selecting a graphics primitive as set forth in claim 1, wherein the vector data is enlarged or compressed radially with a center of said set enlargement display area as an origin.

3. A method for selecting a graphics primitive as set forth in claim 2, wherein said extracted graphics primitive data is further divided in the respective areas, and said divided vector data are subjected to coordinate transformation with use of a continuously changing an enlargement or compression factor.

4. A graphics primitive selecting apparatus for selecting a graphics primitive in a drawing prepared on a computer, comprising:
area setting unit for setting an enlargement display area wherein enlarged display is provided and a compression display area wherein compressed display is provided in a graphics primitive display area;
graphics extracting unit for extracting graphics primitive data present in said set enlargement and compression display areas;
element dividing unit for dividing said extracted graphics primitive data into a plurality of vector data; and
coordinate transformation unit for subjecting said divided vector data to coordinate transformation to enlarge or compress said extracted graphics primitive data.

5. A computer-readable recording medium for storage of a program therein for causing a computer to function as a graphics primitive selecting apparatus for selecting a graphics primitive in a drawing prepared on the computer, comprising:
area setting program means for setting an enlargement display area wherein enlarged display is provided and a compression display area wherein compressed display is provided in a graphics primitive display area;
graphics extracting program means for extracting graphics primitive data present in said set enlargement and compressed display areas;
element dividing program means for dividing said extracted graphics primitive data into a plurality of vector data; and
coordinate transformation program means for subjecting said divided vector data to coordinate transformation to enlarge or compress said extracted graphics primitive data.
